(19) United States
(12) Patent Application Publication
(10) Pub. No.: US 2013/0342912 A1
(43) Pub. Date: Dec. 26, 2013

(54) Image Reading Device

(71) Applicant: Seiko Epson Corporation, Tokyo (JP)

(72) Inventor: Hidekazu Kobayashi, Nagano-ken (JP)

(21) Appl. No.: 13/919,078

(22) Filed: Jun. 17, 2013

(30) Foreign Application Priority Data
Jun. 21, 2012 (JP) 2012-139425

(51) Int. Cl. G02B 3/00

(52) U.S. Cl. CPC G02B 3/0037
USPC 359/619

(57) ABSTRACT

By satisfying the first condition, the brightness of the lens array can be obtained while retaining the long diameter of the first lens surface and the second lens surface in the Y direction, and the resolution of the lens array can be improved by decreasing the lens pitch in the X direction. Moreover, by satisfying the second condition, the MTF at the spatial frequency (line pairs/mm) of the lens array can be definitely set to be greater than 0%. As a result, it is possible to provide the CIS module that includes the lens unit having good optical property with a simple configuration.

### CROSS REFERENCE TO RELATED APPLICATION

The entire disclosure of Japanese Patent Application No. 2012-139425, filed Jun. 21, 2012, is expressly incorporated by reference herein.

### BACKGROUND

1. Technical Field

The present invention relates to image reading devices having an imaging optical element that forms an erect equal magnification image by focusing light reflected from a reading object.

2. Related Art

In image scanners, facsimile machines, copying machines and banking terminals and the like, a contact image sensor module (hereinafter, referred to as “CIS module”) is used as an image reading device. Generally, in this type of CIS module, an imaging optical element such as Selfoc (registered trademark) lens array (SLA) is disposed between a reading object and an optical sensor so that light reflected from a reading object is correctly incident on each of a plurality of fine optical sensors that are arranged in line, thereby forming an erect equal magnification image on the optical sensor. Since SLA is expensive, an imaging optical element is provided instead of SLA, for example, as described in JP-A-2010-164974. The imaging optical element described in JP-A-2010-164974 includes a single molded lens array made of a transparent member such as resin and glass and an aperture member having a plurality of through holes that correspond to the respective lenses of the lens array.

An optical property of the single molded lens array is not as good as that of SLA. In order to achieve good optical property, the conventional imaging optical element includes a combination of a plurality of lens arrays each formed by a plurality of lenses arranged in a matrix pattern, and aperture members for preventing occurrence of a stray light that are disposed on the light incident side and the light exit side of the imaging optical element and between the respective lens arrays. Accordingly, the configuration of the imaging optical element is complicated.

### SUMMARY

An advantage of some aspects of the invention is that an image reading device having an imaging optical element which has good optical property with a simple configuration is provided.

According to an aspect of the invention, in an image reading device having an imaging optical element that forms an erect equal magnification image on a sensor by focusing reflected light from a reading object, the imaging optical element includes: a lens array that is formed as a single molded piece of transparent material and includes a plurality of lenses which have respective first lens surfaces through which the reflected light is incident and respective second lens surfaces through which the light which has been incident through the first lens surfaces exits, the plurality of lenses being arranged in a first direction with the respective optical axes of the plurality of lenses being parallel with each other; a light incident aperture member that is disposed between the lens array and the reading object, and has a plurality of light incident through holes that are formed through the light incident aperture member and are arranged in the first direction so that the reflected light passes through the light incident through holes; and a light exit aperture member that is disposed between the lens array and the sensor, and has a plurality of light exit through holes that are formed through the light exit aperture member and are arranged in the first direction so that the reflected light which exits from the second lens surfaces passes through the light exit through holes, wherein when the number of lenses used for forming image is m, a lens pitch is p, a smaller one of long diameters of the first lens surface and the second lens surface in a second direction which is perpendicular to the first direction and an optical axis direction is R, a distance between the reading object and the first lens surface and a focusing surface of the reflected light by the lens array and the second lens surface are d, a defocus amount is Δd, and a spatial frequency is n (line pairs/mm), the imaging optical element satisfies a first condition: R>p and a second condition: p<(d/(2n·Δd))·2/m).

With this configuration, by satisfying the first condition, the brightness of the lens array can be obtained while retaining the long diameter R of the first lens surface and the second lens surface in the second direction, and the resolution of the lens array can be improved by decreasing the lens pitch p in the first direction. Moreover, by satisfying the second condition, the modulated transfer function (MTF) at the spatial frequency n (line pairs/mm) of the lens array (imaging optical element) can be definitely set to be greater than 0%. As a result, it is possible to provide the image reading device that includes the imaging optical element having good optical property with a simple configuration in which the light incident aperture member is disposed on the light incident side and the light exit aperture member is disposed on the light exit side of one lens array.

According to the above aspect of the invention, when a width of the light incident through hole in the first direction is ap1, a thickness of the light incident aperture member in the optical axis direction is t1, and a distance between the reading object and the light incident aperture member is da1, the imaging optical element may further satisfy a third condition: (p+(ap1)/2)/(da1+t1)<(1.5·p)/d.

With this configuration, by satisfying the third condition, the reflected light from the reading object whose optical axis is the same as that of the lens, which is one of the lenses of the lens array, is focused on the sensor by three lenses, which are the above-mentioned lens and two lenses disposed on each side of the above-mentioned lens. Consequently, a clear erect equal magnification image having a small angle of view can be formed on the sensor.

According to the above aspect of the invention, when a width of the light exit through hole in the first direction is ap2, and a distance between the sensor and the light exit aperture member is da2, the imaging optical element may further satisfy a fourth condition: (1.5·p−(ap2)/2)/da2>(2−p)/d.

With this configuration, by satisfying the fourth condition, the reflected light from the reading object whose optical axis is positioned at the boundary between two lenses, which are two adjacent lenses of the lenses of the lens array, is prevented by the light exit aperture member from passing through other lenses than the two lenses and from being focused on the sensor. Consequently, occurrence of a ghost can be prevented and the resolution of the erect equal magnification image formed on the sensor can be improved.

According to another aspect of the invention, in an image reading device having an imaging optical element that forms an erect equal magnification image on a sensor by focusing reflected light from a reading object, the imaging optical element includes: a lens array that is formed as a single molded piece of transparent material and includes a plurality of lenses which have respective first lens surfaces through which the reflected light is incident and respective second lens surfaces through which the light which has been incident through the first lens surfaces exits, the plurality of lenses being arranged in a first direction with the respective optical axes of the plurality of lenses being parallel with each other; and a light exit aperture member that is disposed between the lens array and the sensor, and has a plurality of light exit through holes that are formed through the light exit aperture member and are arranged in the first direction so that the reflected light which exits from the second lens surfaces passes through the light exit through holes, wherein the first lens surface and the second lens surface are formed in an identical shape, and when the number of lenses used for forming image is m, a lens pitch is p, a long diameter of the first lens surface and the second lens surface in a second direction which is perpendicular to the first direction and an optical axis direction is R, a distance between the reading object and the first lens surface and a focusing surface of the reflected light by the lens array and the second lens surface are d, a defocus amount is Δd, a spatial frequency is n (line pairs/mm), a width of the light exit through hole in the first direction is ap2, a thickness of the light exit aperture member in the optical axis direction is t2, and a distance between the sensor and the light exit aperture member is da2, the imaging optical element satisfies all the following conditions:

a first condition: R>p
a second condition: p<(d/(2n·Δd))·(2/m)
a fifth condition: (p+(ap2)/2)/(da2+t2)<(1.5·p)/d
a sixth condition: (1.5·p−(ap2)/2)/da2>(ap2)/(t2).

With this configuration, by satisfying the first condition, the brightness of the lens array can be obtained while retaining the long diameter R of the first lens surface and the second lens surface in the second direction, and the resolution of the lens array can be improved by decreasing the lens pitch p in the first direction. Moreover, by satisfying the second condition, the MTF at the spatial frequency n (line pairs/mm) of the lens array (imaging optical element) can be definitely set to be greater than 0%. As a result, it is possible to provide the image reading device that includes the imaging optical element having good optical property with a simple configuration in which the light exit aperture member is disposed on the light exit side of one lens array.

Further, by satisfying the fifth condition, the reflected light from the reading object whose optical axis is the same as that of the lens, which is one of the lenses of the lens array, is focused on the sensor by three lenses, which are the above-mentioned lens and lenses disposed on each side of the above-mentioned lens. Consequently, a clear erect equal magnification image having a small angle of view can be formed on the sensor.

Further, by satisfying the sixth condition, the reflected light from the reading object whose optical axis is positioned at the boundary between two lenses, which are two adjacent lenses of the lenses of the lens array, is prevented by the light exit aperture member 43 from passing through other lenses than the two lenses and from being focused on the sensor. Consequently, occurrence of a ghost can be prevented and the resolution of the erect equal magnification image formed on the sensor can be improved.

Moreover, since there is no need to provide an aperture member on the light incident side of the lens array, the clearance between the reading object and the imaging optical element can be increased, which allows a design freedom to be increased.

According to another aspect of the invention, in an image reading device having an imaging optical element that forms an erect equal magnification image on a sensor by focusing reflected light from a reading object, the imaging optical element includes: a lens array that is formed as a single molded piece of transparent material and includes a plurality of lenses which have respective first lens surfaces through which the reflected light is incident and respective second lens surfaces through which the light which has been incident through the first lens surfaces exits, the plurality of lenses being arranged in a first direction with the respective optical axes of the plurality of lenses being parallel with each other; and a light incident aperture member that is disposed between the lens array and the reading object, and has a plurality of light incident through holes that are formed through the light incident aperture member and are arranged in the first direction so that the reflected light passes through the light incident through holes, wherein the first lens surface and the second lens surface are formed in an identical shape, and when the number of lenses used for forming image is m, a lens pitch is p, a long diameter of the first lens surface and the second lens surface in a second direction which is perpendicular to the first direction and an optical axis direction is R, a distance between the reading object and the first lens surface and a focusing surface of the reflected light by the lens array and the second lens surface are d, a defocus amount is Δd, a spatial frequency is n (line pairs/mm), a width of the light incident through hole in the first direction is apt, a thickness of the light exit aperture member in the optical axis direction is t1, and a distance between the sensor and the light incident aperture member is da1, the imaging optical element satisfies all the following conditions:

a first condition: R>p
a second condition: p<(d/(2n·Δd))·(2/m)
a seventh condition: (p+(ap1)/2)/(da1+t1)<(1.5·p)/d
an eighth condition: (1.5·p−(ap1)/2)/da1>(ap1)/(t1).

With this configuration, by satisfying the first condition, the brightness of the lens array can be obtained while retaining the long diameter R of the first lens surface and the second lens surface in the second direction, and the resolution of the lens array can be improved by decreasing the lens pitch p in the first direction. Moreover, by satisfying the second condition, the MTF at the spatial frequency n (line pairs/mm) of the lens array (imaging optical element) can be definitely set to be greater than 0%. As a result, it is possible to provide the image reading device that includes the imaging optical element having good optical property with a simple configuration in which the light incident aperture member is disposed on the light incident side of one lens array.

Further, by satisfying the seventh condition, the reflected light from the reading object whose optical axis is the same as that of the lens, which is one of the lenses of the lens array, is focused on the sensor by three lenses, which are the above-mentioned lens and lenses disposed on each side of the above-mentioned lens. Consequently, a clear erect equal magnification image having a small angle of view can be formed on the sensor.

Further, by satisfying the eighth condition, the reflected light from the reading object whose optical axis is positioned at the boundary between two lenses, which are two adjacent lenses of the lenses of the lens array, is prevented by the light incident aperture member from passing through other lenses than the two lenses and from being focused on the sensor. Consequently, occurrence of a ghost can be prevented and the resolution of the erect equal magnification image formed on the sensor can be improved.

### BRIEF DESCRIPTION OF THE DRAWINGS

The invention will be described with reference to the accompanying drawings, wherein like numbers reference like elements.

FIG. 1 is a perspective view of a CIS module which is a first embodiment of an image reading device according to the invention.

FIG. 2 is a configuration view of a lens unit.

FIG. 3 is a plan view of the lens unit.

FIG. 4 is a configuration view of a lens array.

FIG. 5 is a configuration view of the lens array and an aperture member.

FIG. 6 is a configuration view of a lens array and an aperture member according to a second embodiment.

FIG. 7 is a configuration view of a lens array and an aperture member according to a third embodiment.

### DESCRIPTION OF EXEMPLARY EMBODIMENTS

### First Embodiment

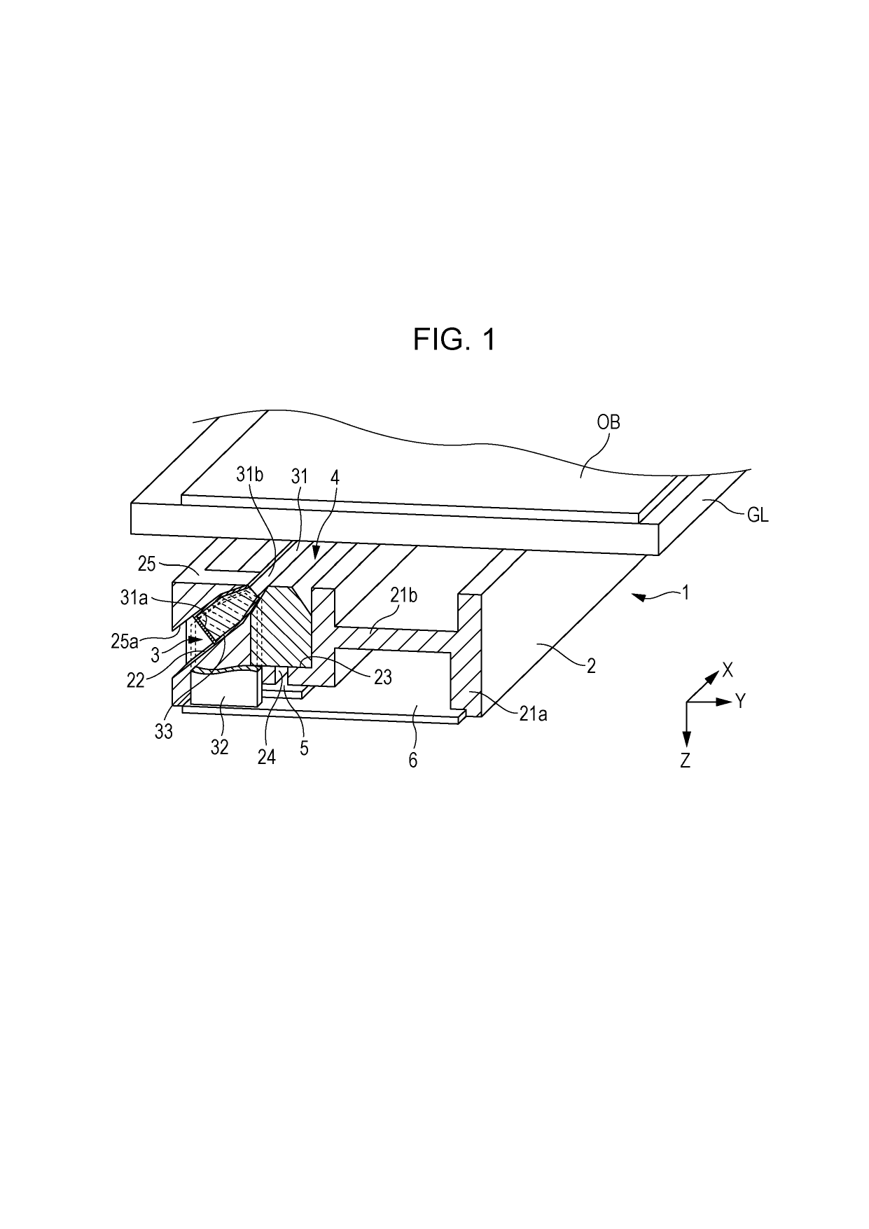

A first embodiment in which an image reading device of the invention is applied to a CIS module will be described below with reference to FIGS. 1 to 5.

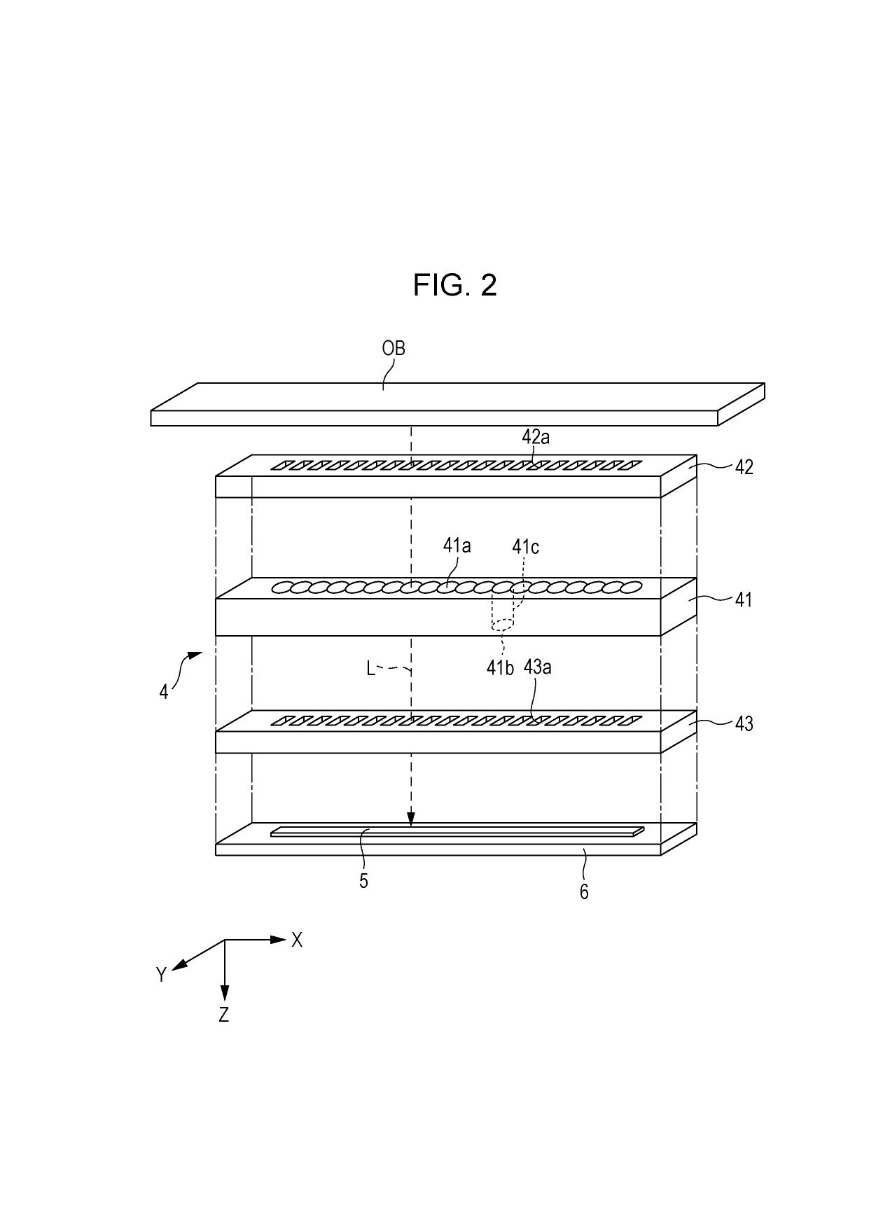

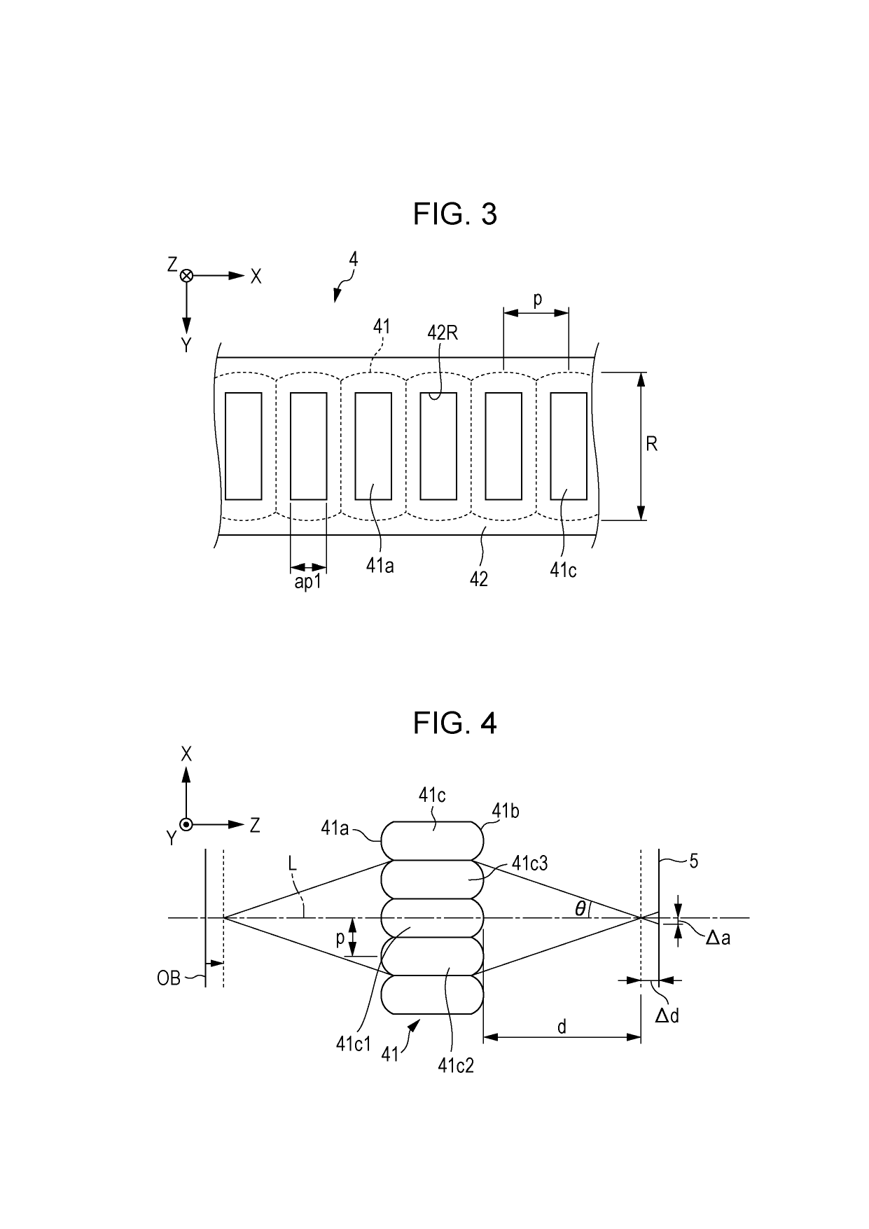

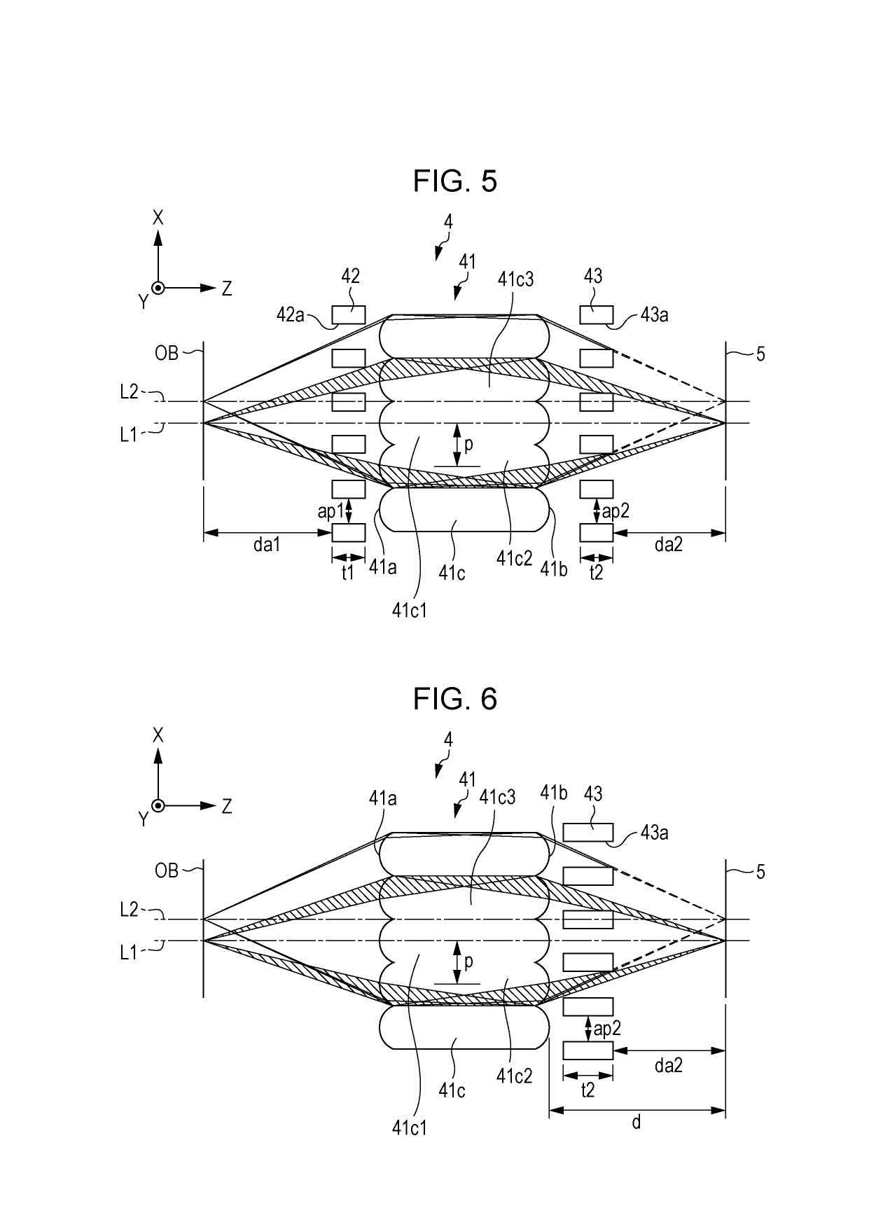

FIG. 1 is a perspective view of the CIS module which is a first embodiment of the image reading device according to the invention. FIG. 2 is a configuration view of a lens unit and FIG. 3 is a plan view of the lens unit. FIG. 4 is a configuration view of a lens array. FIG. 5 is a configuration view of the lens array and an aperture member.

The CIS module 1 is a device that is disposed immediately under a manuscript glass GL and reads an image printed on a manuscript OB which is a reading object placed on the manuscript glass GL. The CIS module 1 includes a frame 2 in a cuboid shape that has a length longer than a reading range of the manuscript OB in the X direction. Further, a lighting unit 3, a lens unit 4 (which corresponds to an “imaging optical element” of the invention), a sensor 5, and a printed circuit board 6 held by the frame 2 are disposed in the frame 2.

The frame 2 includes a frame member 21a and an intermediate member 21b such that an inner space of the frame member 21a is divided by the intermediate member 21b into an upper space in which the lighting unit 3 (light guide 31) and the lens unit 4 are disposed and a lower space in which the sensor 5 and the printed circuit board 6 having a LED substrate 32 of the lighting unit 3 are disposed. Further, in the upper space of the intermediate member 21b, an inclined groove 22 into which the light guide 31 of the lighting unit 3 is inserted and a depressed groove 23 into which the lens unit 4 is inserted are disposed parallel with each other in the X direction. A slit 24 that extends in the X direction is formed on the bottom surface of the depressed groove 23 so that the light having a specific reading width in the X direction exits from the lens unit 4 and passes through the slit 24. The slit 24 communicates the upper space of the frame 2 with the lower space of the frame 2. The inclined groove 22 is inclined to the vertical direction (Z direction in FIG. 1).

A plurality of pressing members 25 are disposed on the frame 2 at positions above the bottom surface of the inclined groove 22 and spaced from each other by a predetermined distance in the X direction and are configured to press the light guide 31 which is disposed in the inclined groove 22. The respective pressing members 25 are integrally formed with the frame 2 and internally extend from a side wall (frame member 2a) of the frame 2 which is adjacent along the inclined groove 22. Further, a pressing surface of the pressing members 25 that are configured to press the light guide 31 which is placed under the pressing members 25 toward the bottom surface of the inclined groove 22 is formed in substantially the same shape as the external periphery of the upper portion of the light guide 31 which is a pressing object.

The light guide 31 that is inserted into the inclined groove 22 from one end of the inclined groove 22 (start point of the X arrow in FIG. 1) is partially overlapped with the lens unit 4 that is inserted into the depressed groove 23 in the X direction in a plan view. When the light guide 31 is pressed by the pressing members 25 from the upper side, a portion of the light guide 31 which is chamfered in the longitudinal direction (X direction) on the lower portion of the light exit surface 31b abuts in the X direction against a portion chamfered in the longitudinal direction (X direction) on the upper left portion of a case of the lens unit 4 that is inserted into the depressed groove 23. When the lens unit 4 is pressed by the light guide 31 which is pressed by the pressing members 25 toward inside of the depressed groove 23, the lens unit 4 is prevented from being disengaged from the depressed groove 23 in a direction opposite to the Z arrow so that the lens unit 4 is held in the depressed groove 23.

The pressing surface of the pressing members 25 is formed in substantially the same shape as the external periphery of the upper portion of the light guide 31 which is a pressing object. Accordingly, when the lens unit 4 is inserted into the depressed groove 23 and the light guide 31 is inserted into the inclined groove 22, the pressing members 25 prevent the light guide 31 from being displaced in a direction other than the insertion direction of the light guide 31 into the inclined groove 22 (X direction), that is, prevent the light guide 31 from being removed from the inclined groove 22. Further, holes 25a each in a rectangular shape are formed on the side wall (frame member 21a) of the frame 2 at positions which correspond to the respective pressing members 25 so as to communicate with the inclined groove 22 through the underside of the pressing member. The holes 25a are formed by obliquely placing a pressing member forming die for forming the inclined groove 22 and the pressing member 25 in the upper space of the frame 2.

A light source is provided as a light emitting diode (LED) (which is not shown in the figure) disposed on a LED substrate 32 which is mounted on the printed circuit board 6. The lighting unit 3 includes a light guide 31 that guides light from the LED to the manuscript OB placed on the manuscript glass GL so as to illuminate the manuscript OB. In FIG. 1, the upper end portion of the LED substrate 32 is indicated by the dotted line and is not illustrated in the figure.

The light guide 31 is made of a transparent member such as acrylic resin and glass and has a length substantially the same as that of a reading range of the CIS module 1. Since the light guide 31 is inserted into the inclined groove 22 provided on the top of the intermediate member 21b, the light guide 31 extends in the X direction. Further, the light guide 31 has a reflection surface 31a that has a reflection structure which reflects the light of the LED incident into the light guide 31 from an end face at one end of the light guide 31 and a light exit surface 31b which allows the light reflected from the reflection surface 31a to exit toward the manuscript OB. The reflection surface 31a and the light exit surface 31b are formed on the external periphery of the light guide 31 in the longitudinal direction so as to oppose each other via the transparent member. In the cross section of the light guide 31 in a direction perpendicular to the longitudinal direction, a width of the light exit surface 31b is smaller than that of the reflection surface 31a.

The cross section of the light guide 31 in the direction perpendicular to the longitudinal direction is a hexagon which is tapered from the side of the reflection surface 31a to the side of the light exit surface 31b. A portion of the light guide 31 which opposes the lens unit 4 is chamfered along the light exit surface 31b in the longitudinal direction. Since the chamfered portion of the light guide 31 is disposed to be in contact with the chamfered portion of the lens unit 4 in the X direction, the light exit surface 31b is disposed adjacent to the lens unit 4. Further, the lighting unit 3 also includes a light shielding film 33 that covers the external periphery of the light guide 31 except for the light exit surface 31b. A scattering surface for scattering light is formed on a side of the light shielding film 33 which is in contact with the light guide 31 (transparent member). In this embodiment, the light shielding film 33 has a thickness of approximately 125 μm.

Since the light guide 31 is inserted into the inclined groove 22, which is provide on the top of the intermediate member 21b of the frame 2 in the X direction, from one end of the inclined groove 22 in front of the plane of the figure with the light exit surface 31b facing the lens unit 4, an insertion space into which the LED substrate 32 is to be inserted is formed at a position of the end face of the light guide 31 in front of the plane of the figure. As shown in FIG. 1, when the printed circuit board 6 with the LED substrate 32 mounted thereon is disposed at a predetermined position in the lower space of the frame 2 and the LED substrate 32 is inserted into the insertion space from the lower side, the distal end face of the LED substrate 32 abuts against the pressing surface of the pressing member 32 and is positioned in place so that the LED on the LED substrate 32 is positioned to oppose the end face of the light guide 31 at one end in the longitudinal direction in front of the plane of the figure.

When the illumination light from the LED is incident on one end of the light guide 31, the illumination light travels through the light guide 31 to the other end of the light guide 31 and is scattered by the reflection surface 31a. The illumination light scattered by the reflection surface 31a is completely reflected by the external periphery (light shielding film 33) in the light guide 31, thereby being collected toward the light exit surface 31b. Then, the collected illumination light exits through the light exit surface 31b toward the manuscript glass GL and is emitted onto the manuscript OB which is placed on the manuscript glass GL. Accordingly, the illumination light extending in the X direction is emitted onto the manuscript OB and is reflected by the manuscript OB.

Further, a biasing unit (not shown in the figure) made of an elastic member such as sponge, rubber and spring is disposed on the inner wall of the frame 2 (frame member 21a) which abuts against the end face at the other end of the light guide 31 which is opposite to the end face at one end of the light guide 31 through which the light from the LED is incident. The light guide 31 is biased by the biasing unit in a direction in which the light guide 31 is removed (disengaged) from the inclined groove 22 (a direction opposite to the X arrow) and abuts against the LED mounted on the LED substrate 32. When the LED substrate 32 which is inserted into the insertion space from the lower side abuts against the inner wall of the frame 2 which opposes the inner wall on which the biasing unit is provided, the LED substrate 32 is positioned in place in a direction in which the LED substrate 32 is pressed by the light guide 31 which is biased by the elastic member. Accordingly, when one end of the light guide 31 which abuts against the LED-mounted surface of the LED substrate 32 is pressed by the LED substrate 32 to be retained in place, the light guide 31 is prevented from being disengaged from the inclined groove 22 and the light guide 31 is retained to be inserted into the inclined groove 2. Accordingly, the light guide 31 is precisely positioned and is secured in the inclined groove 22 between the biasing unit ant the LED substrate 32.

That is, since one end of the light guide 31 which has been inserted from one end of the inclined groove 22 abuts against the LED-mounted surface of the LED substrate 32 and is pressed by the LED substrate 32 to be retained in place, the light from the LED can be incident through one end of the light guide 31 into the light guide 31. Further, since the light guide 31 is prevented from being disengaged from the inclined groove 22 and the light guide 31 is retained to be inserted into the inclined groove 2, there is no need to provide an additional member that prevents the light guide 31 from being disengaged from the inclined groove 22 in addition to the LED. Accordingly, the components of the image reading device 1 can be simplified.

When the light guide 31 is inserted into the inclined groove 22, since the light guide 31 is biased by the biasing unit in the direction in which the light guide 31 is disengaged from the inclined groove 22, one end of the light guide 31 is in close contact with the LED-mounted surface of the LED substrate 32 due to a biasing force from the biasing unit. Accordingly, incident efficiency of the light from the LED incident into the light guide 31 can be improved.

Moreover, the upper space of the frame 2 in which the lighting unit 3 is disposed and the lower space in which the sensor 5 (printed circuit board 6) is disposed are separated from each other by the intermediate member 21b, there is no risk that the light from the lighting unit 3 leaks into the lower space. Accordingly, noise due to the light leaked from lighting unit 3 into the sensor 5 is prevented from being occurred.

The depressed groove 23 is disposed immediately under the illuminated position of the illumination light from the lighting unit 3 and extends in the X direction. Since the lens unit 4 is inserted into the depressed groove 23, the lens unit 4 is disposed in parallel with the light guide 31. The lens unit 4 includes a lens array 41 that has a light incident side on which a plurality of first lens surfaces 41a are arranged in the X direction which is the same as the longitudinal direction of the light guide 31 (which corresponds to the “first direction” of the invention) so that a reflected light L from the manuscript OB is incident onto the first lens surfaces 41a, a light incident aperture member 42 that is disposed between the lens array 41 and the manuscript OB and has a plurality of light incident through holes 42a that are formed through the light incident aperture member 42 and are arranged in the X direction so that the reflected light L passes through the light incident through holes 42a, and a light exit aperture member 43 that is disposed between the lens array 41 and the sensor 5 and has a plurality of light exit through holes 43a that are formed through the light exit aperture member 43 and are arranged in the X direction so that the reflected light L which exits from lens array 41 (second lens surfaces 41b) passes through the light exit through holes 43a. Accordingly, the reflected light L from the manuscript OB is incident onto the light incident side and is focused on the sensor 5, thereby forming an erect equal magnification image of the manuscript OB.

The lens array 41 extends in the X direction by a length substantially the same as the reading range of the CIS module 1. The lens array 41 is formed as a single molded piece of a transparent member such as resin (for example, acrylic resin) and glass which has permeability to the illumination light. Specifically, the lens array 41 includes a plurality of lenses 41c which have respective first lens surfaces 41a through which the reflected light L from the manuscript OB is incident and respective second lens surfaces 41b through which the light L which has been incident through the first lens surfaces 41a exits. The optical axes of the plurality of lenses 41c are parallel with each other and the first lens surfaces 41a and the second lens surfaces 41b are each arranged in the X direction which is the same as the longitudinal direction of the light guide 31. The light incident side of the lens array 41 is formed by the respective first lens surfaces 41a arranged in the X direction, while the light exit surface of the lens array 41 is formed by the respective second lens surfaces 41b arranged in the X direction.

Each first lens surface 41a and each second lens surface 42b are formed in a race track shape which is elongated in the Y direction in a plan view. Specifically, in this embodiment, the lens array 41 has the first lens surface 41a and the second lens surface 42b formed in an identical shape with a lens pitch (the width of the first lens surface 41a the second lens surface 41b in the X direction) defined as p and a long diameter in the Y direction (which corresponds to the “second direction” of the invention) which is perpendicular to the X direction and the optical axis direction (Z direction) of the lens 41c defined as R. Further, as shown in FIG. 4, when the number of lenses used for focusing the reflected light L is m, a distance between the manuscript OB and the first lens surface 41a and between the focusing surface of the reflected light L by the lens array 41 and the second lens surface 41b are d, a defocus amount is Δd, and the spatial frequency is n (line pairs/mm), the lens array 41 is formed to satisfy a first condition: R>p.

In order to set the MTF at the spatial frequency n (line pairs/mm) of the lens array 41 (lens unit 4) to be definitely greater than 0%, defocus must be less than 1/(2n) and the following equation is established:

Tan θ=((m/2)*p)/d=Δa/Δd<(1/(2n))/Δd

Therefore, the lens unit 4 is configured to satisfy a second condition: p<(d/(2n·Δd))·(2/m). Further, m, which is the number of lenses used for focusing the reflected light L, can be, for example, three which are the lens 41c1 into which the optical axis of the reflected light L is incident and lenses 41c2, 41c3 which are disposed on each side of the lens 41c1. With this configuration, resolution can be improved by decreasing the lens pitch p, thereby decreasing the angle of view of the erect equal magnification image focused on the sensor 5.

Moreover, in order to obtain clearer image, the lens pitch p may be set to cause the MTF to be 30% or higher. Specifically, the lens pitch p may be set to satisfy

p<(d/(4n·Δd))·(2/m).

A plurality of through holes 42a are arranged in the X direction on the light incident aperture member 42 of the lens array 41 at positions which correspond to the first lens surfaces 41a of the respective lenses 41c. The through holes 42a regulate an incident direction of the reflected light L which is incident from the manuscript OB. Further, a plurality of through holes 43a are arranged in the X direction on the light exit aperture member 43 of the lens array 41 at positions which correspond to the second lens surfaces 41b of the respective lenses 41c. The through holes 43a regulate an exit direction of the exit light L which exits from the second lens surfaces 41b of the lens array 41. That is, the light incident aperture member 42 which is disposed on the light incident side of the lens array 41 and the light exit aperture member 43 which is disposed on the light exit side of the lens array 41 prevent a stray light from being incident onto the sensor 5.

As shown in FIG. 3, each of the light incident through holes 42a are formed in a rectangular shape having the longitudinal axis which extends in the same direction as the longitudinal axis of the first lens surfaces 41a. Although not shown in the figure, similarly to the light incident through holes 42a, each of the light exit through holes 43a are formed in a rectangular shape having the longitudinal axis which extends in the same direction as the longitudinal axis of the second lens surfaces 41b. With this configuration, the through holes 42a, 43a can be formed to have larger surface area compared with the case where the through holes 42a, 43a are formed in a circular shape. Further, the aperture members 42, 43 can be easily formed by injection molding of resin. The light incident through holes 42a and the light exit through holes 43a may be formed in a race track shape having both short sides in the longitudinal direction curving outward.

As shown in FIG. 5, when a width of the light incident through holes 42a in the X direction is apt, a thickness of the light incident aperture member 42 in the Z direction is t1, and a distance between the manuscript OB and the light incident aperture member 42 is da1, the lens unit 4 is configured to satisfy a third condition: (p+(ap1)/2)/(da1+t1)<(1.5·p)/d, so that the reflected light L1 from the manuscript OB whose optical axis is the same as that of the lens 41c1, which is one of the lenses 41c of the lens array 41, is focused on the sensor 5 by three lenses 41c1 to 41c3, which are the lens 41c1 and lenses 41c2, 41c3 disposed on each side of the lens 41c1.

Further, as shown in FIG. 5, when a width of the light exit through hole 43a in the X direction is ap2, and a distance between the sensor 5 and the light exit aperture member 43 is da2, the lens unit 4 is configured to satisfy a fourth condition: (1.5·p−(ap2)/2)/da2>(2·p)/d, so that the reflected light L2 from the manuscript OB whose optical axis is positioned at the boundary between lenses 41c1 and 41c3, which are two adjacent lenses of the lenses 41c of the lens array 41, is prevented by the light exit aperture member 43 from passing through other lenses 41c than the lenses 41c1, 41c3 and from being focused on the sensor 5.

The slit 24 that extends in the X direction on the bottom surface of the depressed groove 23 that is disposed on the intermediate member 21b of the frame 2 is positioned so that the optical axes of the respective lenses 41c of the lens array 41 on the light exit side are arranged in the X direction. The slit 24 is formed to be slightly wider than the width in the X direction of the optical axes of the respective lenses 41c on the light exit side. The reflected light L which is incident into the lens unit 4 passes through the slit 24 and is focused on the sensor 5 disposed at a position that opposes the slit 24 to form an erect equal magnification image on the sensor 5.

For ease of explanation, although FIG. 2 shows a simplified configuration of the light incident aperture member 42 and the light exit aperture member 43, the light incident aperture member 42 and the light exit aperture member 43 each have a recess into which the lens array 41 is to be fit. When the light incident aperture member 42 and the light exit aperture member 43 are assembled, an inner space is formed for housing the lens array 41. That is, a case for housing the lens array 41 is formed by assembling the light incident aperture member 42 and the light exit aperture member 43. As shown in FIG. 1, a portion of the case which faces the light guide 31 is chamfered in the X direction. As described above, when the chamfered portion of the light guide 31 abuts against the chamfered portion of the case and presses the case into the depressed groove 23, the lens unit 4 (case) is secured in the depressed groove 23 of the frame 2.

The sensor 5 is disposed in the X direction on the printed circuit board 6 with the LED substrate 32 mounted thereon as shown in FIGS. 1 and 2 so as to read the erect equal magnification image of the manuscript OB and output signals associated with the erect equal magnification image.

In assembling of the above described CIS module 1, the lens unit 4 is first fit in the depressed groove 23 that is formed in the upper space of the frame 2 and the light guide 31 is inserted into the inclined groove 31. Then, the printed circuit board 6 is positioned at a specified position in the lower space of the frame 2 as shown in FIG. 1, so that the LED substrate 32 is inserted from the lower side into the insertion space, and the assembling of the CIS module 1 is completed.

### First Example

n: 6 (line pairs/mm)
d: 3.5 mm
Δd: 0.3 mm
p: 0.35 mm

### R: 0.8 mm

ap1, ap2: 0.2 mm (the length of the through holes 42a, 43a in the longitudinal direction is 0.5 mm)
t1: 0.5 mm
With the above settings, the lens array 41 and the aperture members 42, 43 were positioned with the distance between the light incident aperture member 42 and the first lens surface 41a being 0.5 mm, and the distance between the light exit aperture member 43 and the second lens surface 41b being 0.85 mm. In the lens unit 4, the results were as follows:

### MTF: 100%

Brightness unevenness in the X direction: 6.5%
Light transmission efficiency: 0.31%

When each first lens surface 41a and each second lens surface 41b were formed in a circular shape with the diameter 0.72 mm, the results were as follows:

### MTF: 88%

Brightness unevenness in the X direction: 6.5%
Light transmission efficiency: 0.25%

### Second Example

n: 6 (line pairs/mm)
d: 3.5 mm
p: 0.35 mm

### R: 0.8 mm

ap1, ap2: 0.2 mm (the length of the through holes 42a, 43a in the longitudinal direction is 0.5 mm)
t1, t2: 0.5 mm
da1: 2.1 mm
da2: 2.125 mm
With the above settings, the lens array 41 and the aperture members 42, 43 were positioned with the distance between the light incident aperture member 42 and the first lens surface 41a being 0.5 mm, and the distance between the light exit aperture member 43 and the second lens surface 41b being 0.85 mm. In the lens unit 4, the results were as follows:

### MTF: 95.2% (Δd: 0 mm)

74.1% (Δd: 0.3 mm)

38.9% (Δd: 0.5 mm)

Brightness unevenness in the X direction: 2.9%
Light transmission efficiency: 0.677%

Therefore, in this embodiment, by satisfying the first condition, the brightness of the lens array 41 can be obtained while retaining the long diameter R of the first lens surface 41a and the second lens surface 41b in the Y direction, and the resolution of the lens array 41 can be improved by decreasing the lens pitch p in the X direction. Moreover, by satisfying the second condition, the MTF at the spatial frequency n (line pairs/mm) of the lens array 41 (lens unit 4) can be definitely set to be greater than 0%. As a result, it is possible to provide the CIS module 1 that includes the lens unit 4 having good optical property with a simple configuration in which the light incident aperture member 42 is disposed on the light incident side and the light exit aperture member 43 is disposed on the light exit side of one lens array 41.

Further, by satisfying the third condition, the reflected light L1 from the manuscript OB whose optical axis is the same as that of the lens 41c1, which is one of the lenses 41c of the lens array 41, is focused on the sensor 5 by three lenses 41c1 to 41c3, which are the lens 41c1 and lenses 41c2, 41c3 disposed on each side of the lens 41c1. Consequently, a clear erect equal magnification image having a small angle of view can be formed on the sensor 5.

Further, by satisfying the fourth condition, the reflected light L2 from the manuscript OB whose optical axis is positioned at the boundary between lenses 41c1 and 41c3, which are two adjacent lenses of the lenses 41c of the lens array 41, is prevented by the light exit aperture member 43 from passing through other lenses 41c than the lenses 41c1, 41c3 and from being focused on the sensor 5. Consequently, occurrence of a ghost can be prevented and the resolution of the erect equal magnification image formed on the sensor 5 can be improved.

The lens unit 4 can be configured with a simple configuration by using a single molded lens array 41 and aperture members 42, 43. As a result, positioning of the components is easier compared with the conventional configuration, and accordingly, the lens unit 4 can be easily assembled. In addition, manufacturing cost of the lens unit 4 can be reduced.

The light incident aperture member 42 enables a function to reduce the angle of view of the erect equal magnification image formed on the sensor 5, and the light exit aperture member 43 enables a function to prevent occurrence of a ghost. Since two functions are independently performed by two aperture members 42, 43, each of the aperture members 42, 43 can have small thicknesses t1, t2, respectively. Consequently, since the clearance between the manuscript OB and the light incident aperture member 42 can be increased, the strength of the manuscript glass GL can be increased by increasing the thickness of the manuscript glass GL. When the aperture members 42, 43 made of resin are molded, yield rate can be improved by decreasing the thickness of the aperture members 42, 43. Further, since the aperture members 42, 43 are positioned on the light incident side and the light exit side of the lens array 41, respectively, stray light can be effectively shielded.

Moreover, since the light incident aperture member 42 and the light exit aperture member 43 are configured in the same configuration, manufacturing cost of the aperture member can be reduced.

### Second Embodiment

A CIS module which is a second embodiment of an image reading device according to the invention will be described below with reference to FIG. 6.

FIG. 6 is a configuration view of a lens array and an aperture member according to the second embodiment. The second embodiment differs from the first embodiment in that the lens unit 4 includes the light exit aperture member 43 only and does not include the light incident aperture member 42 as shown in FIG. 6. The remaining configuration is the same as that of the first embodiment. The same components are denoted by the same reference numerals and will not be described further. The following description focuses on the difference from the first embodiment.

In the second embodiment, similarly to first embodiment, the lens array 41 is configured to satisfy the first condition and the second condition. As shown in FIG. 6, when a width of the light exit through hole 43a in the X direction is ap2, a thickness of the light exit aperture member 43 in the Z direction is t2, and a distance between the sensor 5 and the light exit aperture member 43 is da2, the lens unit 4 is configured to satisfy a fifth condition: (p+(ap2)/2)/(da2+t2)<(1.5·p)/d, so that the reflected light L1 from the manuscript OB whose optical axis is the same as that of the lens 41c1, which is one of the lenses 41c of the lens array 41, is focused on the sensor 5 by three lenses 41c1 to 41c3, which are the lens 41c1 and lenses 41c2, 41c3 disposed on each side of the lens 41c1.

Further, the lens unit 4 is configured to satisfy a sixth condition: (1.5·p−(ap2)/2)/da2>(ap2)/(t2), so that the reflected light L2 from the manuscript OB whose optical axis is positioned at the boundary between lenses 41c1 and 41c3, which are two adjacent lenses of the lenses 41c of the lens array 41, is prevented by the light exit aperture member 43 from passing through other lenses 41c than the lenses 41c1, 41c3 and from being focused on the sensor 5, as shown in FIG. 6.

### Third Example

n: 6 (line pairs/mm)
d: 3.5 mm
p: 0.35 mm

### R: 0.8 mm

ap2: 0.2 mm (the length of the through hole 43a in the longitudinal direction is 0.5 mm)
t2: 1 mm
da2: 2.1 mm
With the above settings, the lens array 41 and the light exit aperture member 43 were positioned to set the distance between the light exit aperture member 43 and the second lens surface 41b to be 0.85 mm. In the lens unit 4, the results were as follows:

### MTF: 70.5% (Δd: −0.3 mm)

95.8% (Δd: 0 mm)

75.8% (Δd: 0.3 mm)

42.9% (Δd: 0.5 mm)

Brightness unevenness in the X direction: 6.4%
Light transmission efficiency: 0.609%

Therefore, in this embodiment, by satisfying the first condition, the brightness of the lens array 41 can be obtained while retaining the long diameter R of the first lens surface 41a and the second lens surface 41b in the Y direction, and the resolution of the lens array 41 can be improved by decreasing the lens pitch p in the X direction. Moreover, by satisfying the second condition, the MTF at the spatial frequency n (line pairs/mm) of the lens array 41 (lens unit 4) can be definitely set to be greater than 0%. As a result, it is possible to provide the CIS module 1 that includes the lens unit 4 having good optical property with a simple configuration in which the light exit aperture member 43 is disposed on the light exit side of one lens array 41.

Further, by satisfying the fifth condition, the reflected light L1 from the manuscript OB whose optical axis is the same as that of the lens 41c1, which is one of the lenses 41c of the lens array 41, is focused on the sensor 5 by three lenses 41c1 to 41c3, which are the lens 41c1 and lenses 41c2, 41c3 disposed on each side of the lens 41c1. Consequently, a clear erect equal magnification image having a small angle of view can be formed on the sensor 5.

Further, by satisfying the sixth condition, the reflected light L2 from the manuscript OB whose optical axis is positioned at the boundary between lenses 41c1 and 41c3, which are two adjacent lenses of the lenses 41c of the lens array 41, is prevented by the light exit aperture member 43 from passing through other lenses 41c than the lenses 41c1, 41c3 and from being focused on the sensor 5. Consequently, occurrence of a ghost can be prevented and the resolution of the erect equal magnification image formed on the sensor 5 can be improved.

Moreover, since there is no need to provide an aperture member on the light incident side of the lens array 41, the clearance between the manuscript OB and the lens unit 4 can be increased, which allows a design freedom to be increased.

Since the lens unit 4 is formed by using one light exit aperture member 43, manufacturing cost and manufacturing processes can be reduced. Accordingly, it is possible to provide the CIS module 1 that includes the eco-friendly and economic lens unit 4.

### Third Embodiment

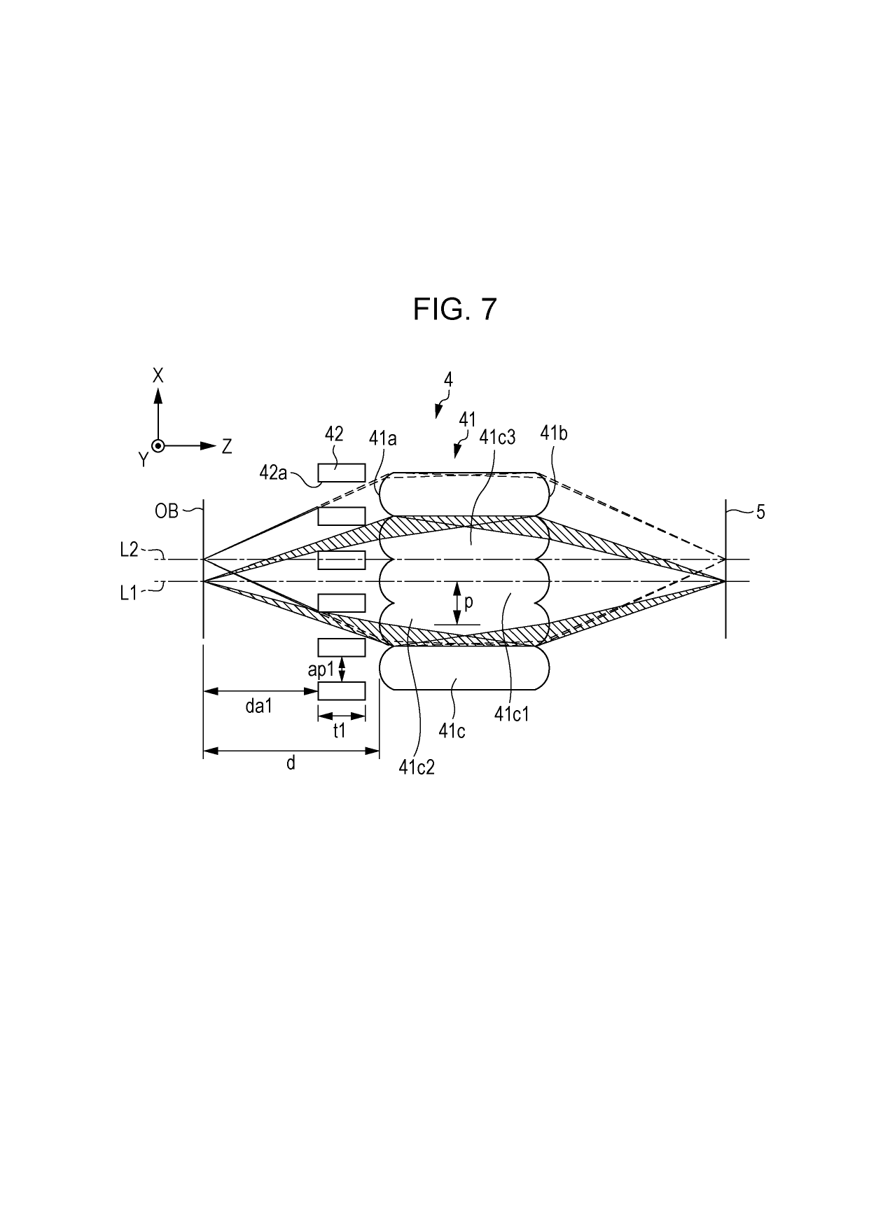

A CIS module which is a third embodiment of an image reading device according to the invention will be described below with reference to FIG. 7.

FIG. 7 is a configuration view of a lens array and an aperture member according to the third embodiment. The third embodiment differs from the first embodiment in that the lens unit 4 includes the light incident aperture member 42 only and does not include the light exit aperture member 43 as shown in FIG. 7. The remaining configuration is the same as that of the first embodiment. The same components are denoted by the same reference numerals and will not be described further. The following description focuses on the difference from the first embodiment.

In this embodiment, similarly to first embodiment, the lens array 41 is configured to satisfy the first condition and the second condition. As shown in FIG. 7, when a width of the light incident through hole 42a in the X direction is ap1, a thickness of the light incident aperture member 42 in the Z direction is t1, and a distance between the sensor 5 and the light incident aperture member 42 is da1, the lens unit 4 is configured to satisfy a seventh condition: (p+(ap1)/2)/(da1+t1)<(1.5·p)/d, so that the reflected light L1 from the manuscript OB whose optical axis is the same as that of the lens 41c1, which is one of the lenses 41c of the lens array 41, is focused on the sensor 5 by three lenses 41c1 to 41c3, which are the lens 41c1 and lenses 41c2, 41c3 disposed on each side of the lens 41c1.

Further, the lens unit 4 is configured to satisfy an eighth condition: (1.5·p−(ap1)/2)/da1>(ap1)/(t1), so that the reflected light L2 from the manuscript OB whose optical axis is positioned at the boundary between lenses 41c1 and 41c3, which are two adjacent lenses of the lenses 41c of the lens array 41, is prevented by the light incident aperture member 42 from passing through other lenses 41c than the lenses 41c1, 41c3 and from being focused on the sensor 5, as shown in FIG. 7.

### Fourth Example

n: 6 (line pairs/mm)
d: 3.5 mm
p: 0.35 mm

### R: 0.8 mm

ap1: 0.2 mm (the length of the through hole through hole 43a in the longitudinal direction is 0.5 mm)
t1: 1 mm
da1: 2.1 mm
With the above settings, the lens array 41 and the light incident aperture member 42 were positioned to set the distance between the light incident aperture member 42 and the first lens surface 41a to be 0.5 mm. In the lens unit 4, the results were as follows:

### MTF: 82.0% (Δd: −0.3 mm)

95.8% (Δd: 0 mm)

63.7% (Δd: 0.3 mm)

37.7% (Δd: 0.5 mm)

Brightness unevenness in the X direction: 4.3%
Light transmission efficiency: 0.585%

Therefore, in this embodiment, by satisfying the first condition, the brightness of the lens array 41 can be obtained while retaining the long diameter R of the first lens surface 41a and the second lens surface 41b in the Y direction, and the resolution of the lens array 41 can be improved by decreasing the lens pitch p in the X direction. Moreover, by satisfying the second condition, the MTF at the spatial frequency n (line pairs/mm) of the lens array 41 (lens unit 4) can be definitely set to be greater than 0%. As a result, it is possible to provide the CIS module 1 that includes the lens unit 4 having good optical property with a simple configuration in which the light incident aperture member 42 is disposed on the light incident side of one lens array 41.

Further, by satisfying the seventh condition, the reflected light L1 from the manuscript OB whose optical axis is the same as that of the lens 41c1, which is one of the lenses 41c of the lens array 41, is focused on the sensor 5 by three lenses 41c1 to 41c3, which are the lens 41c1 and lenses 41c2, 41c3 disposed on each side of the lens 41c1. Consequently, a clear erect equal magnification image having a small angle of view can be formed on the sensor 5.

Further, by satisfying the eighth condition, the reflected light L2 from the manuscript OB whose optical axis is positioned at the boundary between lenses 41c1 and 41c3, which are two adjacent lenses of the lenses 41c of the lens array 41, is prevented by the light incident aperture member 42 from passing through other lenses 41c than the lenses 41c1, 41c3 and from being focused on the sensor 5. Consequently, occurrence of a ghost can be prevented and the resolution of the erect equal magnification image formed on the sensor 5 can be improved.

Since the lens unit 4 is formed by using one light incident aperture member 42, manufacturing cost and manufacturing processes can be reduced. Accordingly, it is possible to provide the CIS module 1 that includes the eco-friendly and economic lens unit 4.

The invention is not limited to the above-mentioned embodiments, and various modifications can be made to the invention without departing from the spirit of the invention. For example, all the above-mentioned configurations of the lens unit 4 are merely exemplary. The configurations of the lens unit 4 may be designed to satisfy the above conditions as appropriate depending on the configuration and optical property of the lens unit required for the image reading device. Further, the aperture may have different cross sectional shapes in the optical axis direction at the light incident side and the light exit side within the acceptable range of the above-mentioned conditions. For example, a tapered shape such as trapezoid may be possible. Such a taper of the aperture can improve mold release ability during resin molding.

The cross sectional shape of the light guide 31 in a direction perpendicular to the longitudinal direction may not be limited to the hexagon as described above, and may be any shape such as trapezoid, rectangular and pentagon. Although the case of the lens unit 4 is described as being formed by assembling the aperture members 42, 43 in the above embodiments, the aperture members may be formed, for example, in a plate-shape as shown in FIG. 2 and the lens array and the aperture member may be configured to be directly mounted on the frame 2.

The invention may be broadly applied to image reading devices having an imaging optical element that forms an erect equal magnification image by focusing reflected light from a reading object.

What is claimed is:

1. An image reading device having an imaging optical element that forms an erect equal magnification image on a sensor by focusing reflected light from a reading object, the imaging optical element comprising:
a lens array that is formed as a single molded piece of transparent material and includes a plurality of lenses which have respective first lens surfaces through which the reflected light is incident and respective second lens surfaces through which the light which has been incident through the first lens surfaces exits, the plurality of lenses being arranged in a first direction with the respective optical axes of the plurality of lenses being parallel with each other;
a light incident aperture member that is disposed between the lens array and the reading object, and has a plurality of light incident through holes that are formed through the light incident aperture member and are arranged in the first direction so that the reflected light passes through the light incident through holes; and
a light exit aperture member that is disposed between the lens array and the sensor, and has a plurality of light exit through holes that are formed through the light exit aperture member and are arranged in the first direction so that the reflected light which exits from the second lens surfaces passes through the light exit through holes,
wherein when the number of lenses used for forming image is m, a lens pitch is p, a smaller one of long diameters of the first lens surface and the second lens surface in a second direction which is perpendicular to the first direction and an optical axis direction is R, a distance between the reading object and the first lens surface and a focusing surface of the reflected light by the lens array and the second lens surface are d, a defocus amount is Δd, and a spatial frequency is n (line pairs/mm), the imaging optical element satisfies a first condition: R>p and a second condition: p<(d/(2n·Δd))·(2/m).

2. The image reading device according to claim 1, wherein when a width of the light incident through hole in the first direction is ap1, a thickness of the light incident aperture member in the optical axis direction is t1, and a distance between the reading object and the light incident aperture member is da1, the imaging optical element further satisfies a third condition: (p+(ap1)/2)/(da1+t1)<(1.5·p)/d.

3. The image reading device according to claim 1, wherein when a width of the light exit through hole in the first direction is ap2, and a distance between the sensor and the light exit aperture member is da2, the imaging optical element further satisfies a fourth condition: (1.5·p−(ap2)/2)/da2>(2·p)/d.

4. An image reading device having an imaging optical element that forms an erect equal magnification image on a sensor by focusing reflected light from a reading object, the imaging optical element comprising:
a lens array that is formed as a single molded piece of transparent material and includes a plurality of lenses which have respective first lens surfaces through which the reflected light is incident and respective second lens surfaces through which the light which has been incident through the first lens surfaces exits, the plurality of lenses being arranged in a first direction with the respective optical axes of the plurality of lenses being parallel with each other; and
a light exit aperture member that is disposed between the lens array and the sensor, and has a plurality of light exit through holes that are formed through the light exit aperture member and are arranged in the first direction so that the reflected light which exits from the second lens surfaces passes through the light exit through holes,
wherein the first lens surface and the second lens surface are formed in an identical shape, and
when the number of lenses used for forming image is m, a lens pitch is p, a long diameter of the first lens surface and the second lens surface in a second direction which is perpendicular to the first direction and an optical axis direction is R, a distance between the reading object and the first lens surface and a focusing surface of the reflected light by the lens array and the second lens surface are d, a defocus amount is Δd, a spatial frequency is n (line pairs/mm), a width of the light exit through hole in the first direction is ap2, a thickness of the light exit aperture member in the optical axis direction is t2, and a distance between the sensor and the light exit aperture member is da2, the imaging optical element satisfies all the following conditions:
a first condition: R>p
a second condition: p<(d/(2n·Δd))·(2/m)
a fifth condition: (p+(ap2)/2)/(da2+t2)<(1.5·p)/d
a sixth condition: (1.5·p−(ap2)/2)/da2>(ap2)/(t2).

5. An image reading device having an imaging optical element that forms an erect equal magnification image on a sensor by focusing reflected light from a reading object, the imaging optical element comprising:
a lens array that is formed as a single molded piece of transparent material and includes a plurality of lenses which have respective first lens surfaces through which the reflected light is incident and respective second lens surfaces through which the light which has been incident through the first lens surfaces exits, the plurality of lenses being arranged in a first direction with the respective optical axes of the plurality of lenses being parallel with each other; and
a light incident aperture member that is disposed between the lens array and the reading object, and has a plurality of light incident through holes that are formed through the light incident aperture member and are arranged in the first direction so that the reflected light passes through the light incident through holes,
wherein the first lens surface and the second lens surface are formed in an identical shape, and
when the number of lenses used for forming image is m, a lens pitch is p, a long diameter of the first lens surface and the second lens surface in a second direction which is perpendicular to the first direction and an optical axis direction is R, a distance between the reading object and the first lens surface and a focusing surface of the reflected light by the lens array and the second lens surface are d, a defocus amount is Δd, a spatial frequency is n (line pairs/mm), a width of the light incident through hole in the first direction is apt, a thickness of the light exit aperture member in the optical axis direction is t1, and a distance between the sensor and the light incident aperture member is da1, the imaging optical element satisfies all the following conditions:
a first condition: R>p
a second condition: p<(d/(2n·Δd))·(2/m)
a seventh condition: (p+(ap1)/2)/(da1+t1)<(1.5·p)/d
an eighth condition: (1.5·p−(ap1)/2)/da1>(ap1)/(t1).
